(19) United States
(12) Patent Application Publication
(10) Pub. No.: US 2026/0208699 A1
(43) Pub. Date: Jul. 23, 2026

(54) ADAPTER FOR WINDSCREEN WIPER BLADE AND WIPING SYSTEM

(71) Applicant: VALEO SYSTEMES D'ESSUYAGE, La Verriere (FR)

(72) Inventors: Vincent GAUCHER, La Verriere (FR); Stephane HOUSSAT, La Verriere (FR); Olivier JOMARD, La Verriere (FR)

(73) Assignee: VALEO SYSTEMES D'ESSUYAGE, La Verriere (FR)

(21) Appl. No.: 19/134,843

(22) PCT Filed: Dec. 11, 2023
(86) PCT No.: PCT/EP2023/085207

§ 371 Date: Jun. 2, 2025

(30) Foreign Application Priority Data
Dec. 14, 2022 (FR) FR2213401

(51) Int. Cl. B60S 1/40

(52) U.S. Cl. CPC B60S 1/407

(57) ABSTRACT

The invention relates to an adapter for a windscreen wiper blade, which is configured to be able to assemble a windscreen wiper blade to a windscreen wiper arm. The adapter includes an arm cavity, which is configured to receive one end of the windscreen wiper arm sliding in a longitudinal direction, and a locking button, which is configured to block the removal of the windscreen wiper arm in the longitudinal direction. The arm cavity includes at least one first bearing zone, on which one edge of the arm is configured to bear, and two second bearing zones, on which the opposite edge of the arm is configured to bear, the first and second bearing zones being arranged so as to bear alternately on each edge of the arm along the arm.

### TECHNICAL FIELD

The present invention relates to an adapter for a wiper blade, configured to be able to assemble a wiper blade to a wiper arm intended to be connected to a motorized wiper mechanism of a vehicle. Another subject of the invention is a wiping device comprising a wiper arm and a wiper blade connected to said arm by means of said adapter.

### BACKGROUND OF THE INVENTION

Motor vehicles are commonly equipped with wiper systems that are intended to clean their glazed surfaces, and in particular their windshield. Such wiper systems comprise a wiper arm and a wiper blade driven by said arm. The wiper arm is connected to an electric motor of the vehicle and the wiper blade comprises at least one wiper rubber adapted to come into contact with the glazed surface to be wiped. In order to be able to drive the wiper blade, an adapter is arranged between the wiper arm and a connector of the blade.

There are various kinds of arms, such as hook arms, arms with a lateral pivot pin, arms with longitudinal clip-fastening, rod arms, etc.

An adapter is thus specifically configured to cooperate with a rod arm. Rod arms are flat and have the advantage of being compact as a result of their small thickness.

The rod arm is inserted by sliding into a housing of the adapter. In use, the withdrawal of the arm by longitudinal movement is prevented in a locking zone of the adapter as a result of releasing a push button that engages in a dedicated lateral cutout of the arm.

The rod arms have more or less complex shapes at the zone of connection to the adapter, in particular as a result of various existing locking solutions. The section of the rod is generally rectangular with rounded edge faces but generally has a reduction in section that can reach more than 50% in the locking zone. However, this change in section can make the holding of the arm and the guiding thereof difficult and imprecise over the entire length of the connector.

### SUMMARY OF THE INVENTION

One of the aims of the present invention is to propose an adapter that at least partially solves a drawback of the prior art.

To this end, one subject of the invention is an adapter for a wiper blade, configured to be able to assemble a wiper blade to a wiper arm, the adapter having:
an arm housing configured to receive an end of the wiper arm by sliding in a longitudinal direction, and
a locking button configured to block the withdrawal of the wiper arm in the longitudinal direction,
   characterized in that the arm housing has at least one first bearing zone on which one edge face of the arm is configured to bear and two second bearing zones on which the opposite edge face of the arm is configured to bear, the first and second bearing zones being disposed so as to come to bear alternately on each edge face of the arm along the arm.

The alternation of the bearing zones bearing on each edge face of the arm along the arm makes it possible to correctly guide the sliding of the arm in the arm housing. Thus, although the section of the end of the rod of the arm does not completely fill the sections of the entry cage and of the end gutter as a result of a section that is smaller at the end, the arm can be correctly held and correctly guided, even at its end. Good precision of the guiding is thus maintained while at the same time maintaining isostatism. In addition, the adapter is simple to produce, lightweight and easy to unmold.

The adapter can also have one or more of the features that are described below, taken alone or in combination.

The arm housing may have a single first bearing zone bearing on one edge face of the arm and two second bearing zones bearing on the opposite edge face.

The second bearing zones may have a respective rounded “U” shape complementary to the rounded edge face of the rod of the arm.

The second bearing zones may respectively be formed in internal flanks of an entry cage and of an end gutter of the arm housing, which are aligned in the longitudinal direction of the arm.

The second bearing zones may have at least two internal longitudinal ribs.

The at least one first bearing zone may have a flat shape complementary to the flat edge face of the rod of the arm.

The at least one first bearing zone may be created in a protrusion of the adapter projecting into a blocking volume of the adapter.

The at least one first bearing zone may be provided in a corner of the protrusion of the adapter.

The corner may be formed on the one hand by the first bearing zone and on the other hand by a longitudinal stop of the adapter that is configured to cooperate with a complementary surface formed in the edge face of the wiper arm so as to block the longitudinal insertion of the wiper arm into the arm housing.

Another subject of the invention is a wiping device comprising a wiper arm, in particular a rod-arm, and a wiper blade, characterized in that it comprises an adapter as described above, for connecting the wiper blade to the end of the wiper arm.

### BRIEF DESCRIPTION OF DRAWINGS

Other advantages and features will become apparent on studying the following description of a particular, but in no way limiting, embodiment of the invention, and also the appended drawings, in which:

FIG. 1 is a perspective view of a first exemplary embodiment of a wiping device.

FIG. 2 is a perspective view of an adapter connected to a rod of the wiper arm of the wiping device in FIG. 1.

FIG. 3 shows a bottom view of the adapter connected to the rod of the wiper arm in FIG. 2.

FIG. 4 shows another view of the adapter connected to the rod of the wiper arm in FIG. 3.

FIG. 5 shows a perspective view of the rod of the wiper arm in FIG. 3 FIG. 3.

FIG. 6 is a perspective view of a second exemplary embodiment of a wiping device.

FIG. 7 is a perspective view of an adapter connected to a rod of the wiper arm of the wiping device in FIG. 6.

FIG. 8 shows a bottom view of the adapter connected to the rod of the wiper arm in FIG. 7.

FIG. 9 shows another view of the adapter connected to the rod of the wiper arm in FIG. 8.

FIG. 10 is an enlarged view of a detail of the adapter in FIG. 9.

FIG. 11 shows an enlarged view of the end of the rod of the wiper arm in FIG. 9.

In these figures, identical elements bear the same reference numerals.

### DETAILED DESCRIPTION OF THE INVENTION

The following embodiments are examples. Although the description refers to one or more embodiments, this does not necessarily mean that each reference relates to the same embodiment, or that the features apply only to a single embodiment. Individual features of different embodiments can also be combined or interchanged to provide other embodiments.

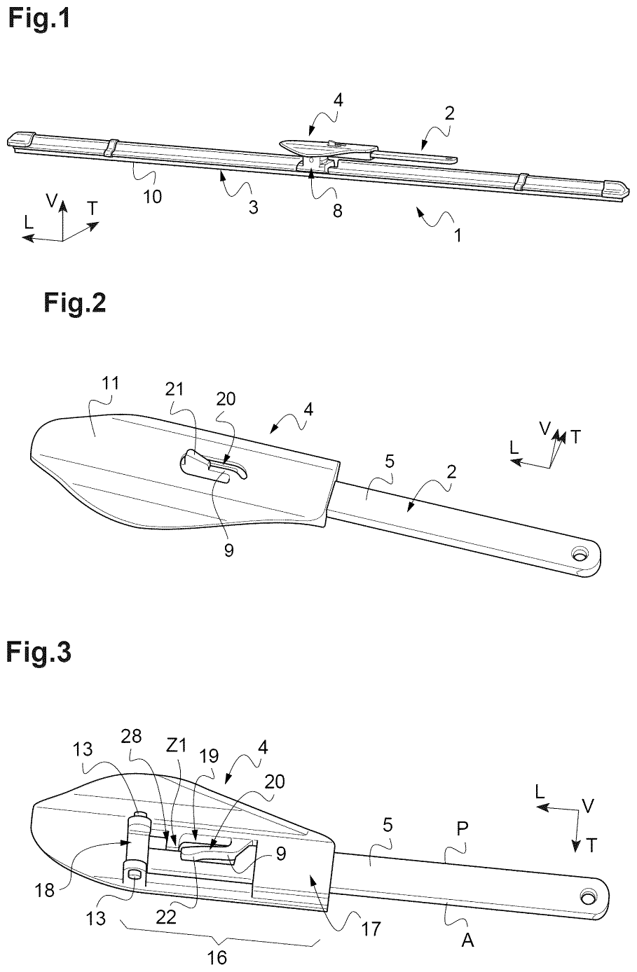

In the remainder of the description, longitudinal, vertical and transverse directions indicated in particular in FIG. 1 by the trihedron (L, T, V) that is fixed with respect to the adapter will be adopted in a non-limiting manner. The longitudinal direction L corresponds to the main direction of the adapter. The vertical direction V and transverse direction T are perpendicular to the longitudinal direction L and perpendicular to each other.

FIG. 1 shows a first exemplary wiping device 1.

The wiping device 1 comprises a wiper arm 2 intended to be connected to a motorized wiper mechanism of a vehicle and of which the end is connected to a wiper blade 3 by means of an adapter 4, so as to clean a glazed surface of the vehicle, for example a windshield.

The arm 2 is of the rod-arm type, it comprises a rod 5 connected to a base of the arm 2, which is itself intended to be connected to the motorized mechanism. The rod 5 extends between an end connected to the base and an end cooperating with the adapter 4 for connection to the blade 3. The term “rod” is understood to mean a solid element of which the end extends in the longitudinal direction L. As it can be more clearly seen more clearly in FIG. 5, the rod 5 is “flat”, i.e. it has two faces that are flat and parallel to each other and connected to each other in the longitudinal direction by two opposite edge faces A, P. The section of the rod 5 is rectangular with rounded edge faces A, P outside a locking zone and the rod 5 has a reduced section in the locking zone for locking with the adapter 4, only one edge face A being rounded.

As it can be more particularly seen in FIG. 2 and FIG. 3, the adapter 4 extends mainly along the longitudinal direction L. It comprises an upper wall 11 that has for example a smooth and curved profile, this wall being the one that is visible when the wiping device 1 is mounted on a vehicle.

On the back of this upper wall 11, and as it can be seen in FIG. 3, the adapter 4 has elements that make it possible on the one hand to lock the arm 2 to the adapter 4 and on the other hand to assemble the wiper blade 3 to the wiper arm 2 in an articulated manner.

In order to connect the adapter 4 to the blade 3, the adapter 4 has rotation members complementary to a connector 8 of the wiper blade 3 such as two cylindrical studs 13 configured to cooperate with two complementary holes of the connector 8. The connector 8 is an element of the blade 3 surmounting a wiper rubber 10 of the blade 3 in the middle thereof (FIG. 1).

The rotation between the adapter 4 and the connector 8 is realized about an axis of rotation parallel to the transverse direction T.

In order to receive the end of the arm 2 connecting the arm 2 to the adapter 4, the adapter 4 has an arm housing 16 situated on the back of the upper wall 11.

The housing of the arm 16 passes all the way through in the longitudinal direction L and is configured to receive an end of the wiper arm 2 by sliding in a longitudinal direction L, in particular the rod 5.

In this first exemplary embodiment, the arm housing 16 allows for example the rod 5 to be held in a horizontal position, the parallel faces of the rod 5 being parallel to the plane (L, T) of the adapter 4.

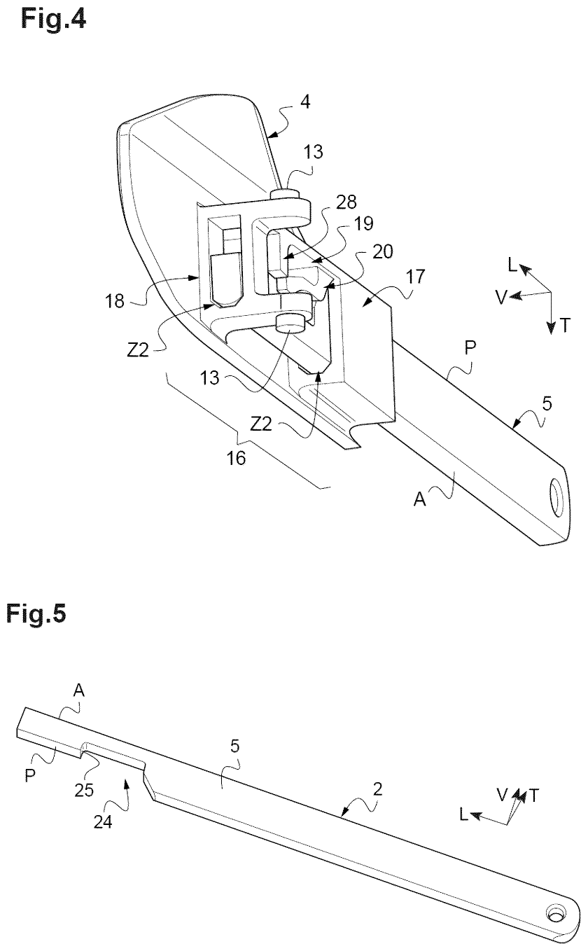

According to one exemplary embodiment, the arm housing 16 has an entry cage 17 and an end gutter 18 that are aligned in the longitudinal direction L of the arm 2. The entry cage 17 and the end gutter 18 are arranged at a distance from one another such that the rod 5 of the arm 2 can be received in the entry cage 17 and the end gutter 18, passing through a blocking volume 19 interposed between the two. The rotation members of the adapter 4, in this case the two cylindrical studs 13, are for example arranged on the end gutter 18 (FIG. 4).

More specifically, the entry cage 17 and the end gutter 18 pass all the way through. The entry cage 17 is for example longer in the longitudinal direction than the end gutter 18 that receives the end of the arm 2. The cross sections (V, T) of the entry cage 17 and of the end gutter 18 are the same. During mounting, the arm 2 slides first into the entry cage 17, then into the end gutter 18.

The adapter 4 also comprises a locking button 20 mounted so as to pivot with respect to the upper wall 11 between a rest position in which it blocks the withdrawal of the arm 2 in the longitudinal direction L and an unlocking position in which it unlocks the longitudinal movement of the arm 2 (FIG. 2).

For this purpose, the locking button 20 has an activation pad 21 on the upper wall 11 side, on which a user can press in order to pivot the locking button 20 into the unlocking position so as to be able to withdraw the arm 2. The locking button 20 also has a blocking member 22 as one with the activation pad 21 and situated on the back of the latter (FIG. 3).

According to a first exemplary embodiment, the activation pad 21 is connected to the upper wall 11 for example by a flexible tab 9 in an opening of the upper wall, the flexible tab 9 being integral with the upper wall 11 so as to allow the locking button 20 to pivot about a vertical pivot axis V. The top of the activation pad 21 may extend beyond the profile of the upper wall 11.

In the rest position, the blocking member 22 is configured to block the longitudinal withdrawal of the arm 2 received in the arm housing 16. The blocking member 22 is for example situated at the end of the activation pad 21 and extends into the blocking volume 19, being received in a notch 24 of the arm 2 in the rest position.

More specifically, the blocking member 22 is configured to engage in a notch 24 of the arm 2 in the blocking volume 19, bearing against a transverse surface 25 of the notch 24, on the side of the end of the arm 2 of the notch 24, so as to prevent the withdrawal of the arm 2 in the longitudinal direction L. The notch 24 of the arm 2 has for example a parallelepipedal shape forming a lateral discontinuity in an edge face of the arm 2 (FIG. 5).

When the user presses on the activation pad 21, the pivoting of the activation pad 21 moves the blocking member 22 away from the transverse surface 25 of the notch 24, and this makes it possible to withdraw the arm 2 in the longitudinal direction.

The arm housing 16 also has at least one first bearing zone Z1 on which one edge face P of the arm 2 is configured to bear (FIG. 3) and two second bearing zones Z2 on which the opposite edge face A of the arm 2 is configured to bear, the first and second bearing zones Z1, Z2 being disposed so as to come to bear alternately on each edge face P, A of the arm 2 along the arm 2 (FIG. 4).

The second bearing zones Z2 have for example a respective rounded “U” shape complementary to the rounded edge face A of the rod 5 of the arm 2.

These second bearing zones Z1, Z2, which have for example a respective “U” shape, may be respectively formed in internal flanks of the entry cage 17 and of the end gutter 18 of the arm housing 16.

The arm housing 16 has for example a single first bearing zone Z1 bearing on one edge face P of the arm 2 and two second bearing zones Z2 bearing on the opposite edge face A. Alternatively, the arm housing 16 may have a plurality of first and second bearing zones Z1, Z2 arranged in a staggered configuration on the opposite edge faces A, P.

The first bearing zone Z1 of the adapter 4 has for example a flat shape complementary to the flat edge face P of the rod 5 of the arm 2 (FIG. 3).

The first bearing zone Z1 is for example created in a protrusion 28 of the adapter 4 projecting into the blocking volume 19 of the adapter 4. The protrusion 28 bearing the first bearing zone Z1 is for example created in an edge of the opening in which the locking button 20 extends (FIG. 3).

The alternation of the bearing zones Z1, Z2 bearing on each edge face A, P of the arm 2 along the arm 2 makes it possible to correctly guide the sliding of the arm 2 in the arm housing 16. Thus, although the section of the end of the rod 5 of the arm 2 does not completely fill the sections of the entry cage 17 and of the end gutter 18 as a result of a section that is smaller at the end, the arm 2 can be correctly held and correctly guided, even at its end. Good precision of the guiding is thus maintained while at the same time maintaining isostatism. In addition, the adapter 4 is simple to produce, lightweight and easy to unmold.

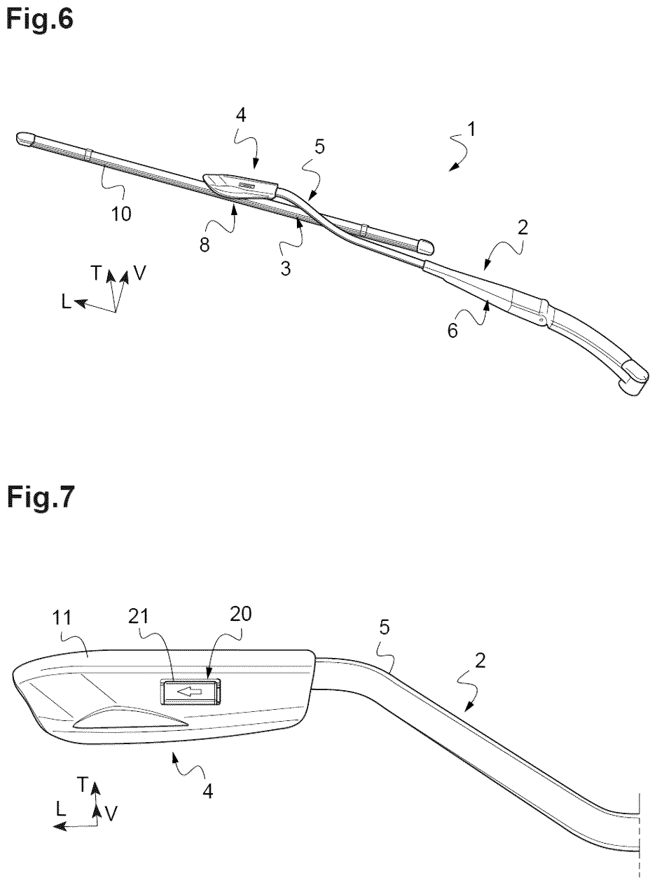

FIG. 6 to FIG. 11 show a second exemplary wiping device 1.

This example differs from the previous one in particular by way of another exemplary connection of the adapter 4 to the blade 3. In this example, the adapter 4 has a connector housing 12 configured to cooperate with the connector 8 of the wiper blade 3.

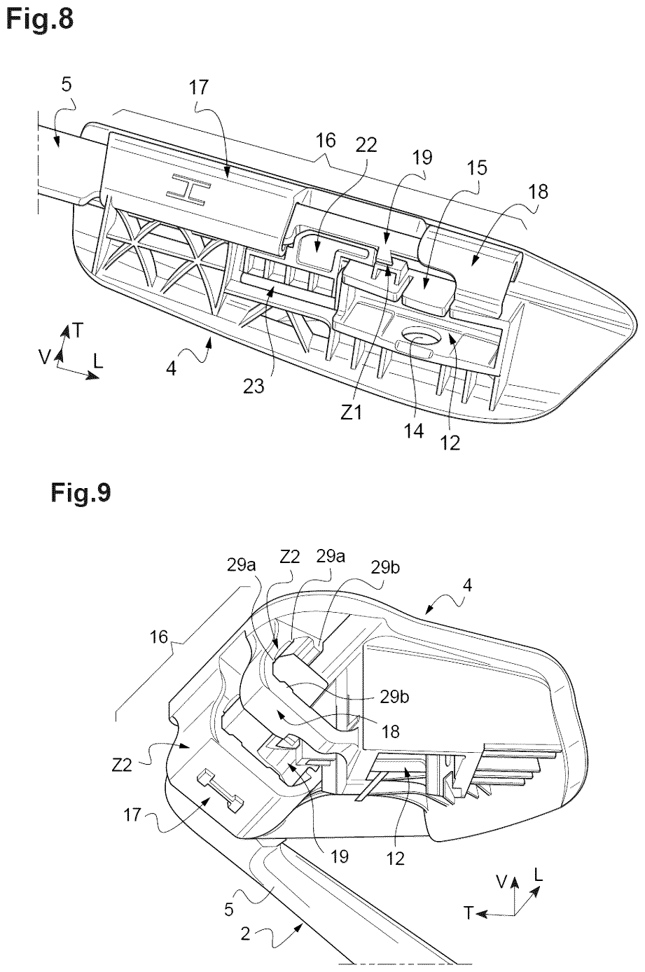

According to one exemplary embodiment of the complementary rotation members, the adapter 4 comprises on the one hand a cylindrical stud configured to cooperate with a circular orifice of the connector 8, and on the other hand a circular hole 14 intended to cooperate with a cylindrical stud of the connector 8, the cylindrical stud 13 and the circular hole 14 being formed in parallel and opposite walls of the connector housing 12 (FIG. 8). The cylindrical stud may be formed in an elastically deformable tongue 15 provided in a wall of the connector housing 12, so as to allow the adapter 4 to be mounted on the connector 8.

This example also differs from the previous one by way of another exemplary embodiment of the locking button 20 (FIG. 7).

In this example, the activation pad 21 is connected to the upper wall 11 for example by a hinge 23 formed on one of the sides of the activation pad 21 so as to allow the locking button 20 to pivot about a longitudinal axis L. The hinge 23 has for example a cross section in the shape of a “U” extending beneath the upper wall 11 (FIG. 8).

The blocking member 22 extends beyond the activation pad 21 into the arm housing 16, on the opposite side from the hinge 23 of the activation pad 21, into the blocking volume 19 situated between the entry cage 17 and the end gutter 18. The blocking member 22 has for example an “L” shape of which one branch is as one with the activation pad 21 and the other branch bears a projecting finger. The projecting finger is received in a notch 24 of the arm 2 in the rest position.

Furthermore, in this example, the arm housing 16 allows the rod 5 to be held in an inclined position with respect to the vertical direction V, the parallel faces of the rod 5 being inclined by an angle for example of between 40° and 60°, such as 45°, with the vertical plane (L, V) of the adapter 4 (FIG. 8).

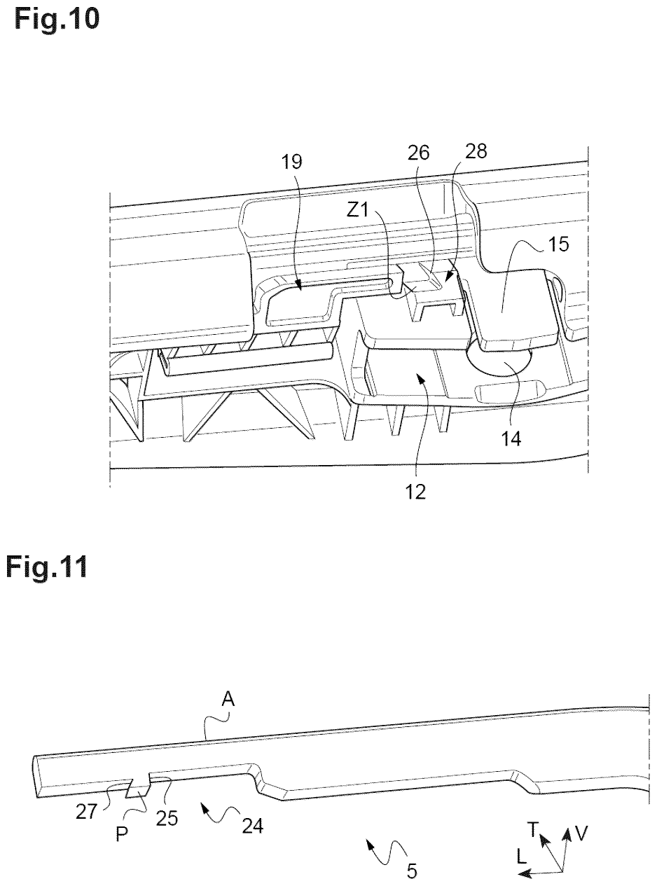

In this example, as in the previous example, the arm housing 16 has at least one first bearing zone Z1 on which one edge face P of the arm 2 is configured to bear (FIGS. 10 and 11) and two second bearing zones Z2 on which the opposite edge face A of the arm 2 is configured to bear, the first and second bearing zones Z1, Z2 being disposed so as to come to bear alternately on each edge face P, A along the arm 2 (FIG. 9).

The arm housing 16 has for example a single first bearing zone Z1 and two second bearing zones Z2.

The second bearing zones Z2 have for example in this case also a respective rounded “U” shape (FIG. 9). Furthermore, in this example, the second bearing zones Z2 have internal longitudinal ribs 29a, 29b. There are for example four internal longitudinal ribs 29a, 29b in each second “U” shaped bearing zone Z2, two internal longitudinal ribs 29a having a narrower cross section in the rounded part of the “U” and two internal longitudinal ribs 29b having a wider cross section on the opposite walls of the entry cage 17 and of the end gutter 18 that are adjacent to the rounded part.

The first bearing zone Z1 has for example a flat shape complementary to the flat edge face of the rod 5 of the arm 2 (FIGS. 10 and 11).

The first bearing zone Z1 is for example created in a protrusion 28 projecting into the blocking volume 19 (FIG. 10).

The protrusion 28 is for example arranged on the back of a wall of the connector housing 12 configured to connect the adapter 4 to the blade 3. This may be the wall of the connector housing 12 in which the tongue 15 bearing the cylindrical stud 13 is provided. The protrusion 28 is situated for example next to the finger of the blocking member 22 in the longitudinal direction, in the rest position.

This first bearing zone Z1 may be provided in a corner, for example of obtuse or acute or right angle, of the protrusion 28 of the adapter 4.

According to one exemplary embodiment, the corner is formed on the one hand by the first bearing zone Z1 and on the other hand by a longitudinal stop 26 of the adapter 4.

The bearing zone Z1 can be inclined so as to come to bear on the edge face P of the rod 5 inclined with respect in particular to the vertical plane (V, L).

The longitudinal stop 26 is arranged projecting into the arm housing 16 and is configured to cooperate with a complementary surface 27 formed in the edge face P of the wiper arm 2 so as to block the longitudinal insertion of the wiper arm 2 into the arm housing 16 (FIG. 11).

The complementary surface 27 of the arm 2 is formed in the edge face P of the rod 5, for example between the end of the arm 2 and the surface of the edge face P bearing on the first bearing zone Z1. This surface is itself formed between the complementary surface 27 of the edge face P and the transverse surface 25 of the notch 24 cooperating with the finger of the blocking member 22.

The longitudinal stop 26 of the adapter 4 creates a limit for the translational movement of the rod 5 of the wiper arm 2 via pressure during the insertion of the arm 2 into the adapter 4 in order to ensure the integrity of the adapter 4. Once the insertion of the arm 2 into the adapter 4 has been solidified by the cooperation of the longitudinal stop 26 of the adapter 4 with the complementary surface 27 of the arm 2, the user can lock the blocking of the arm 2 without risk of damage due to the blocking member 22. The adapter 4 thus offers effective and reliable locking of the arm 2 via a relatively simple means.

The other elements of the wiping device 1 of this second exemplary embodiment are the same as for the first exemplary embodiment.

1. An adapter for a wiper blade, configured to be able to assemble a wiper blade to a wiper arm, the adapter comprising an arm housing configured to receive an end of the wiper arm by sliding in a longitudinal direction and a locking button configured to block the withdrawal of the wiper arm in the longitudinal direction, wherein the arm housing has at least one first bearing zone on which one edge face of the arm is configured to bear and two second bearing zones on which the opposite edge face of the arm is configured to bear, the first and second bearing zones being disposed so as to come to bear alternately on each edge face of the arm along the arm.

2. The adapter according claim 1, wherein the arm housing has a single first bearing zone bearing on one edge face of the arm and two second bearing zones bearing on the opposite edge face.

3. The adapter according to claim 1, wherein the second bearing zones have a respective rounded “U” shape complementary to the rounded edge face of the rod of the arm.

4. The adapter according to claim 1, wherein the second bearing zones are respectively formed in internal flanks of an entry cage and of an end gutter of the arm housing, which are aligned in the longitudinal direction of the arm.

5. The adapter according to claim 1, wherein the second bearing zones have at least two internal longitudinal ribs.

6. The adapter according to claim 1, wherein the at least one first bearing zone has a flat shape complementary to the flat edge face of the rod of the arm.

7. The adapter according to claim 1, wherein the at least one first bearing zone is created in a protuberance of the adapter projecting into a blocking volume of the adapter.

8. The adapter according to claim 7, wherein the at least one first bearing zone is provided in a corner of the protuberance of the adapter.

9. The adapter according to claim 8, wherein the corner is formed on the one hand by the first bearing zone and on the other hand by a longitudinal stop of the adapter that is configured to cooperate with a complementary surface formed in the edge face of the wiper arm so as to block the longitudinal insertion of the wiper arm into the arm housing.

10. A wiping device comprising a rod-arm wiper arm, a wiper blade, and an adapter, with the adapter connecting the wiper blade to the end of the wiper arm, wherein the adapter includes an arm housing configured to receive an end of the wiper arm by sliding in a longitudinal direction and a locking button configured to block the withdrawal of the wiper arm in the longitudinal direction, wherein the arm housing has at least one first bearing zone on which one edge face of the arm is configured to bear and two second bearing zones on which the opposite edge face of the arm is configured to bear, the first and second bearing zones being disposed so as to come to bear alternately on each edge face of the arm along the arm.
